(19) United States
(12) Patent Application Publication
(10) Pub. No.: US 2004/0262100 A1
(43) Pub. Date: Dec. 30, 2004

(54) Driving apparatus and self-brake apparatus thereof

(76) Inventor: Hai-Tao Ma, Hao Chung City (CN)

Correspondence Address: SNELL & WILMER, ONE ARIZONA CENTER, 400 EAST VAN BUREN, PHOENIX, AZ, 850040001

(21) Appl. No.: 10/864,245

(22) Filed: Jun. 9, 2004

(30) Foreign Application Priority Data
Jun. 27, 2003 (TW) 92117582

(51) Int. Cl. F16D 51/00

(52) U.S. Cl. 188/77 R

(57) ABSTRACT

A driving apparatus and a self-brake apparatus are provided. The self-brake apparatus for use with a driving device includes a shaft, a wheel, a stopper and an elastic member. The shaft is driven by the driving device, and the wheel is movably engaged with the shaft. The stopper is positioned on the driving device. When the driving device is inactive, the elastic member provides a force pushing the wheel against the stopper to a motionless state. When the driving device is active, the shaft provides a force driving the wheel departing from the stopper to a rotation state.

### CROSS-REFERENCE TO RELATED APPLICATIONS

This application claims priority to Taiwan Patent Application No. 092117582 entitled “Driving Apparatus and Self-Brake Mechanism Thereof”, filed on Jun. 27, 2003.

### FIELD OF INVENTION

The present invention generally relates to a self-brake apparatus and, more particularly, to a self-brake apparatus for use with a driving device so as to automatically reach a motionless state when the driving device becomes inactive.

### BACKGROUND OF THE INVENTION

A driving apparatus generally transmits power generated by a driving source, such as a motor, to other mediums so that a load can be carried or moved to a predetermined position. However, as size of the mechanical and electrical device becomes intensely reduced, how to carry the load with precision becomes more and more important. Therefore, to reduce shift of the load when the driving source changes from active to inactive is an important consideration of design.

Referring to FIG. 1, a conventional driving apparatus 100, including a driving device 110 (such as a motor), a shaft 122, a wheel and a transmission belt 130 is illustrated. When the driving device 110 is active (for example, powered on or initiated), the driving device 110 drives the shaft 122 to rotate. Due to the engagement of the shaft 122 and the wheel 124, the wheel 124 accordingly responds in a motion state. Therefore, the wheel 124 can be designed to carry a load to a predetermined position. However, as the driving device 110 loses power (for example, turned off), the load may not immediately respond to become motionless, and the shift of the load may occur due to the inertial force. As the load shifts from the predetermined position, the precise control of positioning the load cannot be achieved, and more seriously, components may be damaged because of the shift of the load.

Therefore, there is a need to provide a self-brake apparatus for use with a driving device, so that the driving apparatus can spontaneously reach a motionless state to prevent shift of the load when the driving device changes from active to inactive.

### SUMMARY OF THE INVENTION

One aspect of the present invention is to provide a self-brake apparatus, which automatically reaches a motionless state regardless of an inertial force of a load when a driving device changes from active to inactive or loses power supply.

Another aspect of the present invention is to provide a self-brake apparatus, which spontaneously reaches a motionless state so as to prevent shift of a load and damage of components when a driving device changes from active to inactive.

In one embodiment, the present invention provides a self-brake apparatus for use with a driving device. The self-brake apparatus includes a shaft driven by the driving device, a wheel movably engaged with the shaft, a stopper positioned on the driving device, and an elastic member. When the driving device is inactive, the elastic member provides a force pushing the wheel against the stopper to a motionless state. When the driving device is active, the shaft provides a force driving the wheel departing from the stopper to a rotation state.

In an exemplary embodiment, the shaft has a patterned outer surface, and the wheel has a corresponding patterned inner surface movably engaging with the patterned outer surface so that the wheel is movably engaged with the shaft. For example, the patterned outer surface includes a first inclined pattern and a second inclined pattern. When the driving device drives the shaft, in response to a driving direction, the wheel departs from the stopper selectively along the first inclined pattern and the second inclined pattern. The first inclined pattern and the second inclined pattern are so arranged that the first and second inclined patterns are projected on opposite sides of an axis in a projection plane, or axially disposed.

In another embodiment, the present invention provides a self-brake apparatus for use with a driving device having a shaft. The self-brake apparatus includes a first wheel, a second wheel, a stopper and an elastic member. The first wheel is engaged with the shaft and driven by the driving device. The second wheel is movably engaged with the first wheel. The stopper is positioned on the driving device. When the driving device is inactive, the elastic member provides a force pushing the second wheel against the stopper to a motionless state. When said driving device is active, the first wheel provides a force driving the second wheel departing from the stopper to a rotation state.

In an exemplary embodiment, the first wheel has a raised portion, and the second wheel has a portion corresponding to the raised portion so that the first wheel coaxially engages with the second wheel. The raised portion has a first slant side and a second slant side. When the driving device drives the first wheel, in response to a driving direction, the second wheel departs from the stopper selectively along the first slant side and the second slant side. The first slant side and the second slant side are projected on opposite sides of an axis in a projection plane.

A further aspect of the present invention is to provide a driving apparatus including a driving device and the self-brake apparatus of the preferred embodiments so that the driving apparatus can quickly reach a motionless state when no power is supplied.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a schematic side view of a conventional driving apparatus;

FIG. 2A illustrates a schematic side view of a driving apparatus and a self-brake apparatus thereof in accordance with one embodiment of the present invention;

FIG. 2B illustrates a cross-sectional view of the apparatus illustrated in FIG. 2A;

FIG. 3A illustrates a force diagram of a shaft and a wheel when the shaft is driven in a first direction in accordance with one embodiment of the present invention;

FIG. 3B illustrates a force diagram of a shaft and a wheel when the shaft is driven in a second direction in accordance with one embodiment of the present invention;

FIG. 4A illustrates a force diagram of a shaft and a wheel when the shaft is driven in a first direction in accordance with another embodiment of the present invention;

FIG. 4B illustrates a force diagram of a shaft and a wheel when the shaft is driven in a second direction in accordance with another embodiment of the present invention;

FIG. 5A illustrates a schematic side view of a driving apparatus and a self-brake apparatus thereof in accordance with another embodiment of the present invention;

FIG. 5B illustrates a three-dimensional view of a first wheel and a second wheel of the apparatus illustrated in FIG. 5A;

FIG. 6A illustrates a force diagram of the first and second wheels of FIG. 5A when the first wheel is driven in a first direction; and

FIG. 6B illustrates a force diagram of the first and second wheels of FIG. 5A when the first wheel is driven in a second direction.

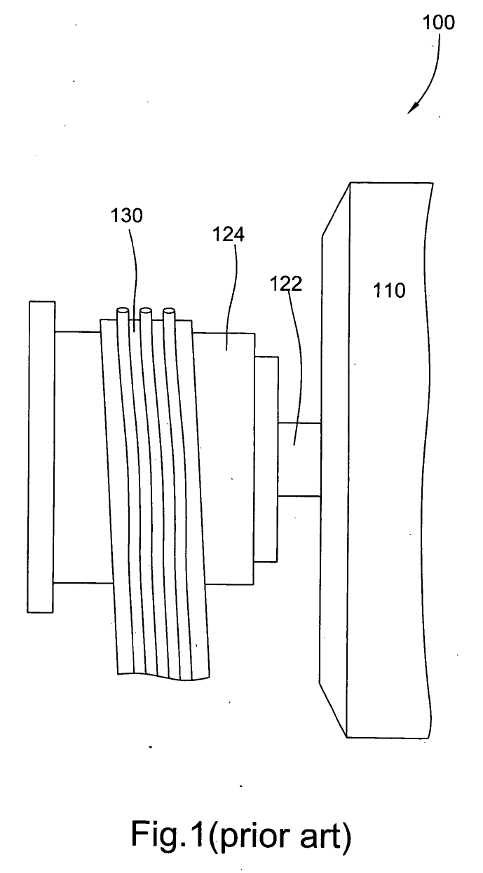

### DETAILED DESCRIPTION OF THE INVENTION

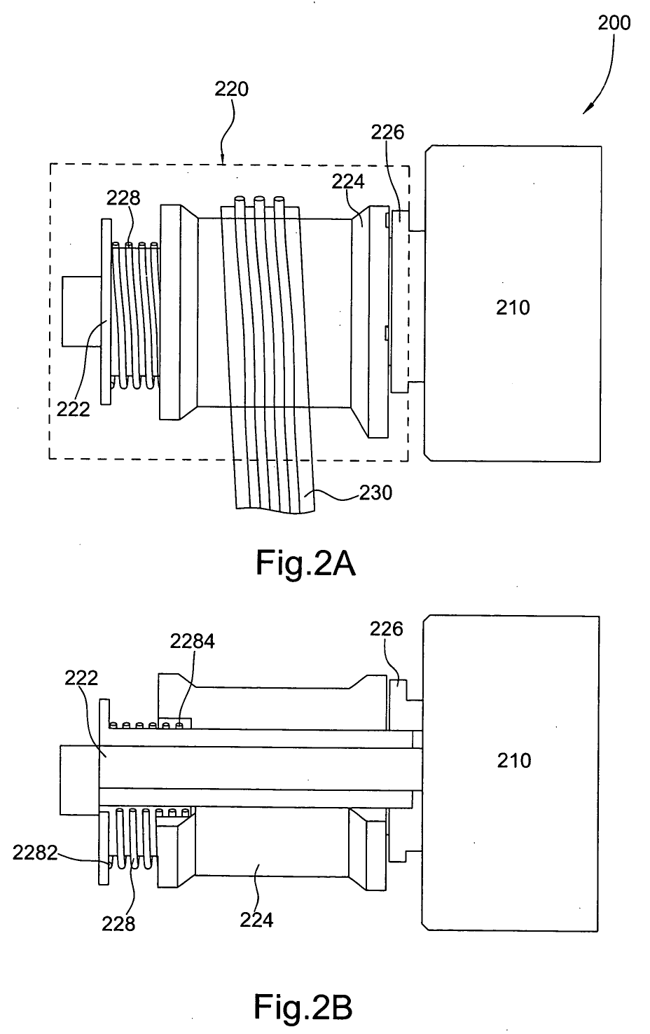

The present invention provides a driving apparatus and a self-brake apparatus thereof, which can quickly reach a motionless state to reduce influences on a carried load when a driving device changes from active to inactive. FIGS. 2-6 illustrate preferred embodiments of the present invention.

Referring to FIGS. 2A and 2B, a schematic side view and a cross-sectional view of a driving apparatus 200 and a self-brake apparatus 220 in accordance with one embodiment of the present invention are illustrated. The driving apparatus 200 includes a driving device 210, a shaft 222, a wheel 224, a stopper 226 and an elastic member 228. The shaft 222, the wheel 224, the stopper 226 and the elastic member 228 constitute the self-brake apparatus 220. The driving device 210, such as a motor, is configured to drive the shaft 222 to rotate. In other words, the shaft 222 rotates in response to the action of the driving device 210. When the driving device 210 is active, the shaft 222 is driven to rotate. The wheel 224 is movably engaged with the shaft 222. The stopper 226 is positioned on the driving device 210 by means of hooks, screws, adhesive, or any appropriate fixing tools, so that the stopper 226 is affixed on the driving device 210.

As shown in FIG. 2B, the wheel 224 coaxially engages with the shaft 222. The elastic member 228 has a first end 2282 and a second end 2284, touching against the shaft 222 and the wheel 224, respectively. The elastic member 228 is disposed on one side of the shaft 222 opposite to the stopper 226. In this exemplary embodiment, the elastic member 228 is a spring, but other suitable elements, such as a spring leaf, can be an alternative embodiment. Moreover, the driving apparatus 200 further includes a transmission belt 230 (see FIG. 2A) for allowing the wheel 224 to carry a load when the driving device 210 is active.

In such a configuration, when the driving device 210 is inactive, the elastic member 228 provides a force pushing the wheel 224 against the stopper 226 to a motionless state. When the driving device 210 is active, the shaft 222 provides a force driving the wheel 224 departing from the stopper 226 to a rotation state. In other words, when the driving device 210 is active, the shaft 222 driven by the driving device 210 provides a force large enough to overcome the resilient force of the elastic member 228 so that the wheel 224 movably engaged with the shat 222 departs from the stopper 226 to carry the load. Furthermore, when the driving device 210 changes from active to inactive or loses power stopping driving the shaft 222, the shaft 222 stops providing any force to drive the wheel 224, so that the wheel 224 is pushed against the stopper 226 by the resilient force of the elastic member 228. Therefore, the self-brake apparatus 210 quickly reaches the motionless state so as to prevent shift induced by the inertial force of the load.

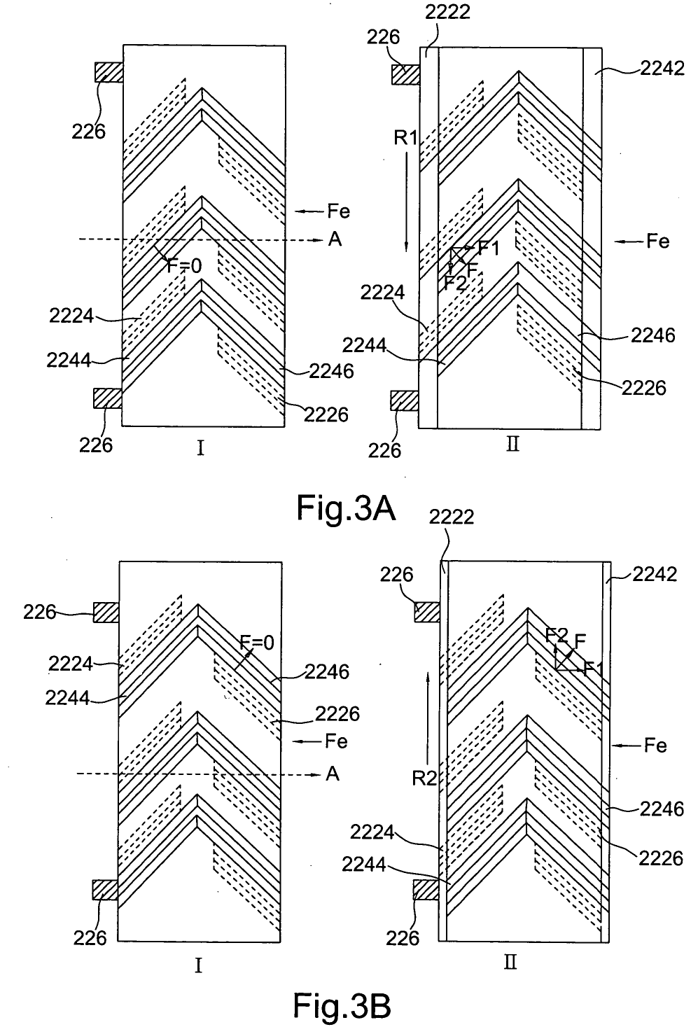

FIGS. 3A and 3B illustrate schematic force diagrams of the shaft 222 and the wheel 224 when selectively driven in a first direction R1 and a second direction R2 respectively. As shown in FIGS. 3A and 3B, the shaft 222 has a patterned outer surface 2222, and the wheel 224 has a corresponding patterned inner surface 2242 movably engaging with the patterned outer surface 2222. In other words, for example, the patterned outer surface 2222 includes a first inclined pattern 2224 and a second inclined pattern 2226 (or referred as a first tooth and a second tooth), while the inner surface 2242 of the wheel 224 has a third inclined pattern 2244 and a fourth inclined pattern 2246 (or referred as a third tooth and a fourth tooth). The first inclined pattern 2224 and the second inclined pattern 2226 are sequentially arranged along an axis “A” of the shaft 222 or the wheel 224. That is, the first and second inclined patterns 2224 and 2226 are spirally arranged around the axis “A”. Similarly, the third inclined pattern 2244 and the fourth inclined pattern 2246 are arranged to correspond to the first inclined pattern 2224 and the second inclined pattern 2226 respectively. It is noted that the design of inclined direction of each pattern depends on the driven direction of the driving device 210.

Referring to FIG. 3A-I, when the driving device 210 is inactive, the force provided by the shaft 222 substantially equals to zero (F=0), and the force provided by the elastic member 228 is substantially great than zero (Fe>0). Therefore, the wheel 224 is pushed against the stopper 226 by the force, “Fe”. In this configuration, the first and second inclined patterns 2224, 2226 touch against the third and fourth inclined patterns 2244, 2246 respectively. As shown in FIG. 3A-II, when the driving device 210 drives the shaft 222 in the first direction “R1”, the wheel 224 departs from the stopper 226 along the first inclined pattern 2224 toward the direction of axis “A”. For example, when the driving device 210 drives the shaft 222 in the first direction “R1”, the shaft 222 provides a force “F”, which generates a first component force “F1” opposite to the resilient force “Fe” and a second component force “F2” in the driving direction (i.e. the first direction “R1”). The first component force “F1” neutralizes the resilient force “Fe”, so that the wheel 224 can depart from the stopper 226 and begin to rotate due to the second component force “F2”. In this configuration, the second inclined pattern 2226 detaches from the fourth inclined pattern 2246, and no force is exerted thereon.

Referring to FIG. 3B-I, when the driving device 210 is inactive, the force diagram of the shaft 222, the wheel 224 and the elastic member 228 is similar to that illustrated in FIG. 3A-I, and not elaborated hereinafter. As shown in FIG. 3B-II, when the driving device 210 drives the shaft 222 in the second direction “R2” (opposite to the first direction “R1”), the wheel 224 departs from the stopper 226 along the second inclined pattern 2226 toward the direction of axis “A”. For example, when the driving device 210 drives the shaft 222 in the second direction “R2”, the shaft 222 provides a force “F”, which generates a first component force “F1” opposite to the resilient force “Fe” and a second component force “F2” in the driving direction (i.e. the second direction “R2”). The first component force “F1” neutralizes the resilient force “Fe”, so that the wheel 224 can depart from the stopper 226 and begin to rotate due to the second component force “F2”. In this configuration, the first inclines pattern 2224 detaches from the third inclined pattern 2244, and no force is exerted thereon.

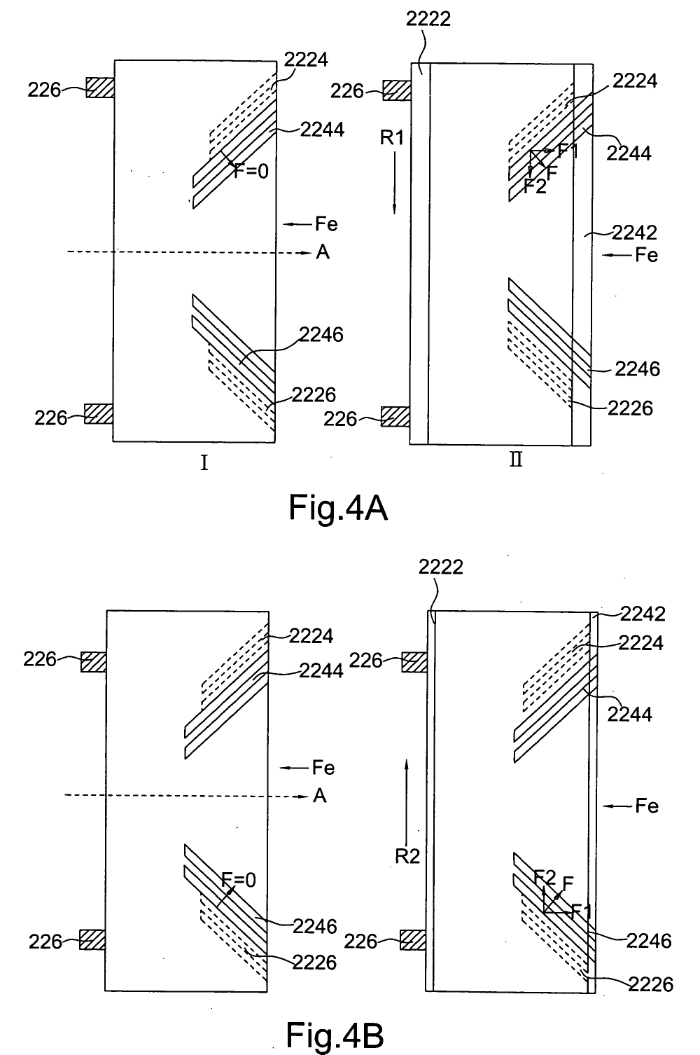

FIGS. 4A and 4B illustrate force diagrams of the shaft 222 and the wheel 224 when selectively driven in the first and second directions, “R1”, “R2” in accordance with another embodiment of the present invention. Different from that of the embodiment of FIGS. 3A and 3B, the arrangement of the first, second, third and fourth inclined patterns is modified. As shown in FIGS. 4A-I and 4B-I, the shaft 222 has a first inclined pattern 2224 and a second inclined pattern 2226, which are projected on opposite sides of an axis in a projection plane. That is, the first inclined pattern 2224 and the second inclined pattern 2226 are disposed on the outer surface 2222 of the shaft 222 on different sides with respect to the axis “A”. Similarly, the wheel 224 has a corresponding inner surface 2242 with the third inclined pattern 2244 and the fourth inclined pattern 2246 corresponding to the first and the second inclined patterns 2224 and 2226 respectively.

Referring to FIGS. 4A-I and 4B-I, when the driving device 210 is inactive, the force diagram of the shaft 222, the wheel 224, and the elastic member 228 is similar to those illustrated in FIG. 3A-I and 3B-I and not elaborated hereinafter. As shown in FIGS. 4A-II and 4B-II, when the driving device 210 selectively drives the shaft 222 in the first direction “R1” and the second direction “R2”, in response to the driving direction, the wheel 224 departs from the stopper 226 selectively along the first inclined pattern 2224 and the second inclined pattern 2226 toward the axis “A”. In other words, when the driving device 210 is active, the shaft 222 is driven to provide a force “F”, which creates a first component force “F1” opposite to the resilient force “Fe” and a second component force “F2” in the driving direction. The first component force “F1” neutralizes the resilient force “Fe”, so that the wheel 224 departs from the stopper 226 and begins to rotate due to the second component force “F2”.

Moreover, when the driving device 210 stops driving the shaft 222, the load carried by the wheel 224 with an inertial force will induce a component force opposite to the first component force “F1”. As a result, the wheel 224 will be further pushed against the stopper 226 to quickly reach the motionless state.

Furthermore, the stopper 226 has a rough surface for increasing friction between the stopper 226 and the wheel 224 when the wheel 224 is against the stopper 226. Alternatively, the stopper 226 can include a patterned surface, and the wheel 224 has a surface corresponding to the patterned surface so as to engage with the patterned surface of the stopper 226 when the wheel 224 touches against the stopper 226. When the wheel 224 engages with the stopper 226, the shift induced by the inertial force of the wheel 224 is significantly limited. For example, the stopper 226 can have a patterned surface, such as a slot therein, and the wheel 224 has a surface corresponding to the patterned surface, such as a protrusion thereon. Therefore, when the protrusion engages with the slot, the wheel 224 is substantially fixed on the stopper 226 when the driving device 210 is inactive.

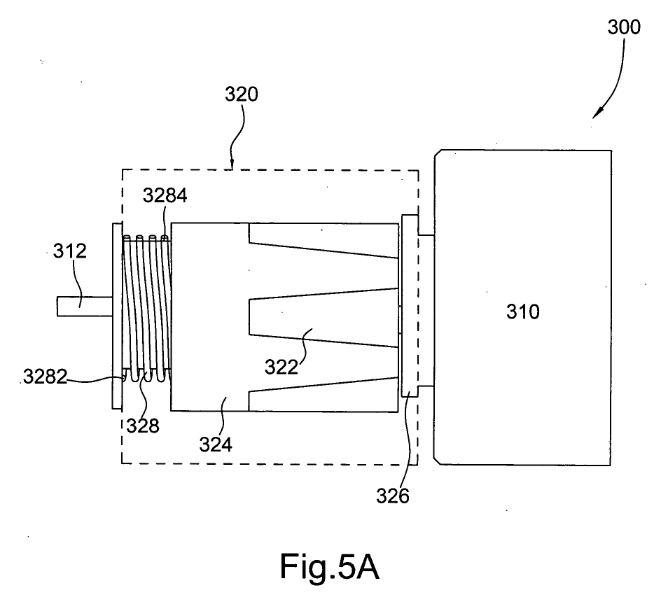

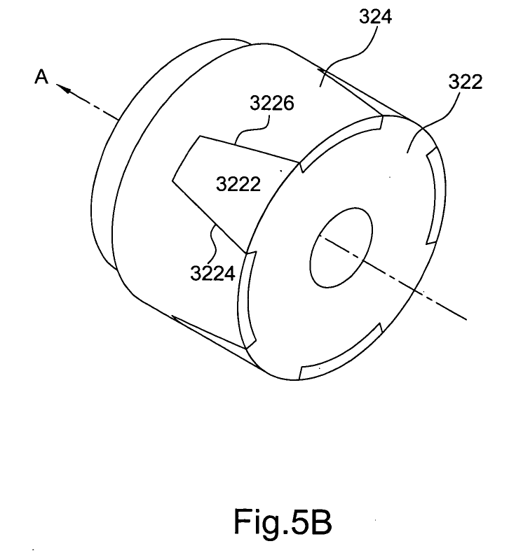

Referring to FIG. 5A, in another embodiment, the present invention provides a driving apparatus 300 and a self-brake apparatus 320 thereof The driving apparatus 300 includes a driving device 310, a first wheel 322, a second wheel 324, a stopper 326 and an elastic member 328. The first wheel 322, the second wheel 324, the stopper 326 and the elastic member 328 constitute the self-brake apparatus 320. Different from the first embodiment, the driving device 310 has a shaft 312, such as a rotation pivot of a commercial motor. In this embodiment, the first wheel 322 is engaged with the shaft 312 so as to be driven by the driving device 310. The second wheel 324 is movably engaged with the first wheel 322. When the driving device 310 is active, the shaft 312 drives the first wheel 322, and accordingly the second wheel 324 is driven. When the driving device 310 is inactive, the elastic member 328 provides a force pushing the second wheel 324 against the stopper 326 to a motionless state. When the driving device 310 is active, the first wheel 322 driven by the shaft 312 provides a force driving the second wheel 324 departing from the stopper 326 to a rotation state.

As shown in FIG. 5A, the stopper 326 is positioned on the driving device 310. The arrangement of the stopper 326 is similar to that of the stopper 226 and not elaborated hereinafter.

The second wheel 324 coaxially engages with the first wheel 322, and the elastic member 328 has a first end 3282 and a second end 3284, touching against the first wheel 322 and the second wheel 324 respectively. FIG. 5B illustrates a three-dimensional view of the first wheel 322 and the second wheel 324. For simplicity, the drawing does not show the relation between the first wheel 322 and the elastic member 328. As shown in FIG. 5B, the first wheel 322 has a raised portion 3222, and the second wheel has a portion corresponding to the raised portion 3222 so that the first wheel 324 coaxially engages with the second wheel 324. Furthermore, the raised portion 3222 has a first slant side 3224 and a second slant side 3226. When the first wheel 322 driven by the driving device 310, in response to the driving direction, the second wheel 324 departs from the stopper 326 selectively along the first slant side 3224 and the second slant side 3226.

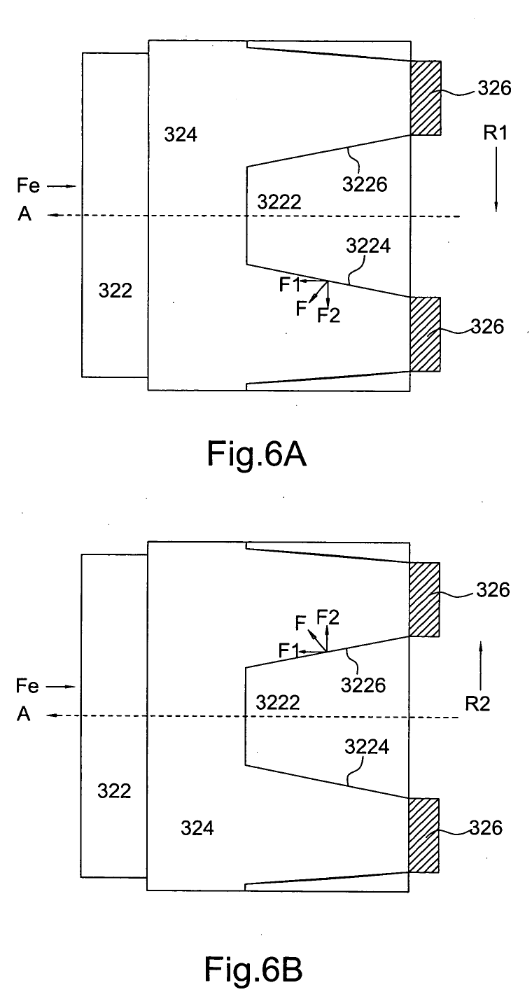

FIGS. 6A and 6B illustrate schematic force diagrams of the first wheel 322 and the second wheel 324 when selectively driven in a first direction R1 and a second direction R2 respectively. As shown in FIG. 6A, the first slant side 3224 and the second slant side 3226 are projected on opposite sides of an axis in a projection plane and have different slant angles (or directions). The structure of the second wheel 324 is designed to correspond to the first and second slant sides 3224, 3226 of the first wheel 322.

Referring to 6A, when the driving device 310 is inactive, the force provided by the first wheel 322 substantially equals to zero (F=0), and the force provided by the elastic member 328 is substantially greater than zero (Fe>0). Therefore, the second wheel 324 is pushed against the stopper 326 by the force, “Fe”. When the driving device 310 drives the first wheel 322 in the first direction “R1”, the second wheel 324 departs from the stopper 326 along the first slant side 3224 toward the direction of axis “A”. For example, when the driving device 310 drives the first wheel 322 in the first direction “R1”, the first wheel 322 provides a force “F”, which generates a first component force “F1” opposite to the resilient force “Fe” and a second component force “F2” in the driving direction (i.e. the first direction “R1”). The first component force “F1” neutralizes the resilient force “Fe”, so that the second wheel 324 can depart from the stopper 326 and begin to rotate due to the second component force “F2”.

Similarly, when the driving device 310 drives the first wheel 322 in the second direction “R2”, the second wheel 324 departs from the stopper 326 along the second slant side 3224 toward the direction of axis “A”. For example, when the driving device 310 drives the first wheel 322 in the second direction “R2”, the first wheel 322 provides a force “F”, which generates a first component force “F1” opposite to the resilient force “Fe” and a second component force “F2” in the driving direction (i.e. the second direction “R2”). The first component force “F1” neutralizes the resilient force “Fe”, so that the second wheel 324 can depart from the stopper 326 and begin to rotate due to the second component force “F2”. Moreover, when the driving device 310 changes to inactive, the shaft 312 and the first wheel 322 stop rotating due to the loss of a driving force. When the second wheel 324 carries a load, a component force induced by the inertial force of the load, which is opposite to the first component force “F1”, will further push the second wheel 324 against the stopper 326.

It is noted that the shaft 222 of the first embodiment can also be designed to have a raised portion as that of the first wheel 322, and the wheel 224 can have a corresponding portion as the second wheel 324 does. Therefore, the wheel can coaxially and movably engage with the shaft 222 to quickly reach the motionless state when the driving device 210 is inactive. Furthermore, due to the design of the first and second inclined patterns 2224, 2226 and the first and second slant sides 3224, 3226, whatever the driving device 210 or 310 drives the shaft 212 or 312 in the first direction or the second direction (i.e. clockwise or counterclockwise), the wheel 224 or the second wheel 324 can depart from the stopper 226 or 326 and rotate in the same direction.

Although specific embodiments have been illustrated and described, it will be obvious to those skilled in the art that various modifications may be made without departing from what is intended to be limited solely by the appended claims.

I claim:

1. A self-brake apparatus for use with a driving device, comprising:
a shaft driven by said driving device;
a wheel movably engaged with said shaft;
a stopper positioned on said driving device; and
an elastic member;
wherein said elastic member provides a force pushing said wheel against said stopper to a motionless state when said driving device is inactive, and said shaft provides a force driving said wheel departing from said stopper to a rotation state when said driving device is active.

2. The self-brake apparatus of claim 1, wherein said shaft has a patterned outer surface, and said wheel has a corresponding patterned inner surface movably engaging with said patterned outer surface.

3. The self-brake apparatus of claim 2, wherein said patterned outer surface comprises a first inclined pattern, and said wheel departs from said stopper along said first inclined pattern when said driving device drives said shaft in a first direction.

4. The self-brake apparatus of claim 3, wherein said patterned outer surface further comprises a second inclined pattern, and said wheel departs from said stopper along said second inclined pattern when said driving device drives said shaft in a second direction opposite to said first direction.

5. The self-brake apparatus of claim 4, wherein said first inclined pattern and said second inclined pattern are projected on opposite sides of an axis in a projection plane.

6. The self-brake apparatus of claim 4, wherein said first inclined pattern and said second inclined pattern are axially disposed.

7. The self-brake apparatus of claim 1, wherein said shaft has a raised portion, and said wheel has a portion corresponding to said raised portion so that said wheel coaxially engages with said shaft.

8. The self-brake apparatus of claim 7, wherein said raised portion has a slant side, and said wheel departs from said stopper along said slant side when said driving device drives said shaft.

9. The self-brake apparatus of claim 1, wherein said stopper has a rough surface for increasing friction between said stopper and said wheel when said wheel is against said stopper.

10. The self-brake apparatus of claim 1, wherein said stopper comprises a patterned surface, and said wheel has a surface corresponding to said patterned surface so as to engage with said patterned surface of said stopper.

11. The self-brake apparatus of claim 1, wherein said wheel coaxially engages with said shaft, and said elastic member has a first end and a second end touch against said shaft and said wheel respectively.

12. A driving apparatus comprising said self-brake apparatus of claim 1.

13. The driving apparatus of claim 12, further comprising a transmission belt for allowing said wheel to carry a load when said driving device is active.

14. A self-brake apparatus for use with a driving device having a shaft, said self-brake apparatus comprising:
a first wheel engaged with said shaft and driven by said driving device;
a second wheel movably engaged with said first wheel;
a stopper positioned on said driving device; and
an elastic member;
wherein said elastic member provides a force pushing said second wheel against said stopper to a motionless state when said driving device is inactive, and said first wheel provides a force driving said second wheel departing from said stopper to a rotation state when said driving device is active.

15. The self-brake apparatus of claim 14, wherein said first wheel has a raised portion, and said second wheel has a portion corresponding to said raised portion so that said first wheel coaxially engages with said second wheel.

16. The self-brake apparatus of claim 15, wherein said raised portion has a slant side, and said second wheel departs from said stopper along said slant side when said driving device drives said first wheel.

17. The self-brake apparatus of claim 15, wherein said raised portion has a first slant side and a second slant side, and said second wheel departs from said stopper selectively along said first slant side and said second slant side when said driving device drives said first wheel.

18. The self-brake apparatus of claim 15, wherein said first slant side and said second slant side are projected on opposite sides of an axis in a projection plane.

19. The self-brake apparatus of claim 14, wherein said stopper has a rough surface for increasing friction between said stopper and said second wheel when said second wheel is against said stopper.

20. The self-brake apparatus of claim 14, wherein said stopper comprises a patterned surface, and said second wheel has a surface corresponding to said patterned surface so as to engage with said patterned surface of said stopper.

21. The self-brake apparatus of claim 14, wherein said second wheel coaxially engages with said first wheel, and said elastic member has a first end and a second end touch against said first wheel and said second wheel respectively.

22. A driving apparatus comprising said self-brake apparatus of claim 13.

23. The driving apparatus of claim 22, further comprising a transmission belt for allowing said wheel to carry a load when said driving device is active.
